(19) United States
(12) Patent Application Publication
(10) Pub. No.: US 2006/0228102 A1
(43) Pub. Date: Oct. 12, 2006

(54) Photographing apparatus and method for compensating brightness of an image

(75) Inventors: Shih-Yang Yang, San Chung City (TW); Chun-Jung Chang, Kaohsiung City (TW)

Correspondence Address: LADAS & PARRY, 26 WEST 61ST STREET, NEW YORK, NY, 10023, US

(73) Assignee: BENQ CORPORATION

(21) Appl. No.: 11/399,809

(22) Filed: Apr. 7, 2006

(30) Foreign Application Priority Data
Apr. 8, 2005 (TW) 94111220

(51) Int. Cl. G03B 7/00

(52) U.S. Cl. 396/213

(57) ABSTRACT

A photographing apparatus includes an image sensor for capturing first and second images sequentially, the first image including a reference image part; a calculation module for calculating average brightness degree of the reference image part for serving as a reference brightness value, wherein a brightness difference between the reference image part and an adjacent part succeeding the reference image part is greater than a threshold, brightness of the first image and the reference brightness value cooperatively defining a compensation ratio; and a compensation module for compensating brightness of the second image according to the compensation ratio.

### FIELD OF THE INVENTION

The present invention relates to a photographing apparatus, more particularly to the photographing apparatus and the method for compensating brightness of an image by the photographing apparatus during taking of a picture.

### BACKGROUND OF THE INVENTION

A digital photographing apparatus is a handy instrument in our daily life, and the photo taken thereby is easy to be handled, such as storing the photo files in addition to editing the photo prior to print out. Therefore, the final product (the printed photo) has high quality in the visual point of view.

However, due to some built-in optical, mechanical components or drawbacks during the assembly process, the brightness supplies to the image exhibited in the display panel of the photographing apparatus is not evenly illuminated, i.e. gradual transition from a brighter image center to darker corners (generally known as vignetting). From a visual point of view, such a photo is out of standard quality, far away from being high quality.

Therefore, the object of the present invention is to provide a photographing apparatus and the compensation method for compensating brightness to the image being capture by the photographing apparatus of the present invention in order to eliminate the drawbacks of the prior art.

### SUMMARY OF THE INVENTION

The object of the present invention is to provide the compensation method and the photographing apparatus in which the shading correction can be to the image being captured so the final product may have high quality in visual aspect.

In one aspect of the present invention, a photographing apparatus is provided to include an image sensor for capturing a first image and a second image sequentially, the first image including a reference image part; a calculation module for calculating average brightness degree of the reference image part as a reference brightness value, wherein a brightness difference between the reference brightness value and average brightness degree of an adjacent part of the first image succeeding the reference image part is greater than a threshold value, brightness of the first image and the reference brightness value cooperatively defining a first compensation ratio; and a compensation module for compensating brightness of the second image according to the first compensation ratio.

In another aspect of the present invention, a compensation method is provided for compensating brightness of an image in a photographing apparatus. The method includes the steps of: (1) capturing a first image, the first image including a reference image part; (2) calculating average brightness degree of the reference image part for serving as a reference brightness value, wherein a brightness difference between the reference image part and an adjacent part succeeding the reference image part is greater than a threshold, brightness of the first image and the reference brightness value cooperatively defining a first compensation ratio; (3) capturing a second image; and (4) compensating brightness of the second image according to the first compensation ratio.

### BRIEF DESCRIPTION OF THE DRAWINGS

Other features and advantages of this invention will become more apparent in the following detailed description of the preferred embodiments of this invention, with reference to the accompanying drawings, in which:

FIG. 1a is a block diagram illustrating a photographing apparatus of the present invention;

FIG. 1b illustrates a display panel of photographing apparatus of the present invention;

FIG. 2a shows a calculation module of the photographing apparatus of the present invention;

FIG. 2b illustrates a calculating path of the photographing apparatus of the present invention in operation;

FIG. 3 illustrates a calculating means of the photographing apparatus of the present invention in operation;

FIG. 4 illustrates how a brightness is compensated to an image being taken by the photographing apparatus of the present invention in operation;

FIG. 5 is a flow chart illustrating brightness compensation method according to the present invention; and

FIG. 6 illustrates how a reference image part is selected in the photographing apparatus of the present invention.

### DETAILED DESCRIPTIONS OF THE PREFERRED EMBODIMENTS

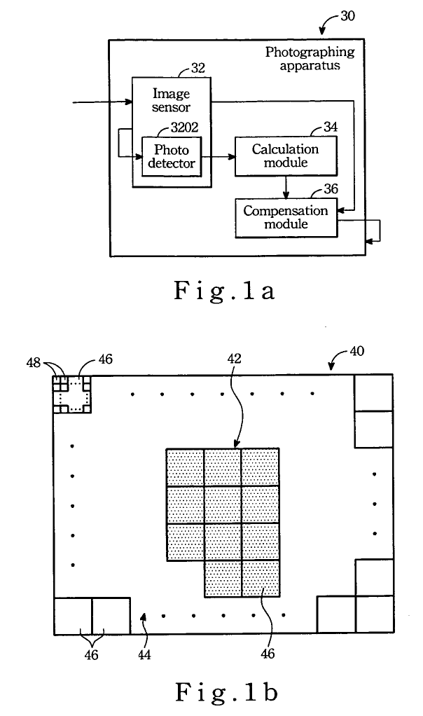

FIG. 1 is a block diagram representing the photographing apparatus 30 according to the present invention, and includes an image sensor 32, a calculation module 34 and a compensation module 36. The photographing apparatus 30 is used to compensate the brightness of an image being taken (by shading correction technology).

The image sensor 32 is used for capturing a first image so as to calculate the brightness degree of the first image for serving as the brightness compensation ratio for compensating brightness of a second image that is captured sequentially after the first image. FIG. 1b is a display panel 40 of the photographing apparatus 30, and shows the first image including a first foreground serving as a reference image part 42 (shown by inclined dotted lines) and a first mono background serving as a non-reference image part 44.

The first image is simply a white wall that is divided into a plurality of first blocks 46. Each first block 46 includes a set of pixel units 48. The image sensor 32 includes a photo detector 3202 for detecting brightness degree of each pixel unit 48 in a respective first block 46.

The calculation module 34 calculates average brightness degree of each pixel unit 48 within the respective first block 46 of the reference image part 42 for serving as a reference brightness value, wherein a bright reference between the reference image part 42 and an adjacent part succeeding the reference image part 42 is greater than a threshold and brightness of the first image and the reference brightness value cooperatively define a first compensation ratio. In addition, the reference brightness value and brightness value of one of the first blocks 46 cooperatively define a second compensation ratio.

The compensation module 36 compensates brightness of the second image according to the first compensation ratio.

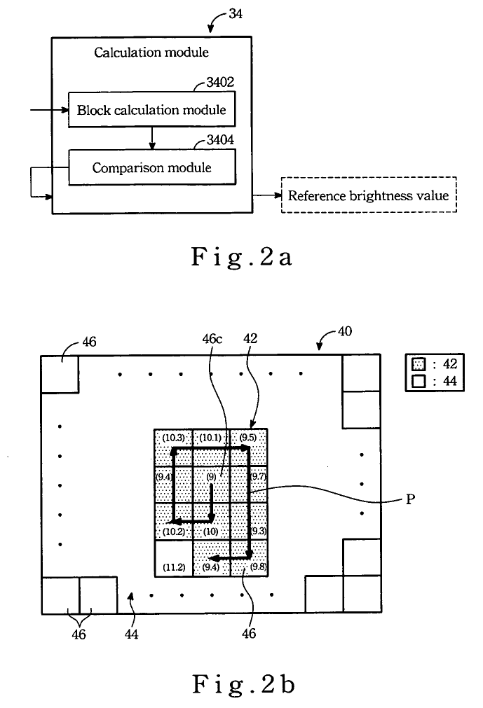

Referring to FIG. 2a, the calculation module 34 further includes a block calculation module 3402 and a comparison module 3404. The block calculation module 3402 calculates average brightness of a respective one of the first blocks 46 according to the pixel value of the pixel unit 48 in each first block 46. The comparison module 3404 compares average brightness degree of adjacent two first blocks 46 in order to select the reference image part 42.

FIGS. 2a and 2b, the second image includes a plurality of the second blocks respectively correspond to the first blocks of the first image in positions. Once the reference image part 42 has been selected, the compensation module 36 selects one of the second blocks 46 from the non-reference image part 44 of the second image, and compensates the second block 46 the same as the first block. FIG. 2b shows a predetermined path P defined by the first blocks within the reference image part 42 in the first image. The reference image part 42 preferably includes more than two numbers of the first blocks. The calculation module 34 selects a central first block 46c and later the comparison module 3404 compares the central first block 46c with respect to an adjacent first block 46 along the predetermined path in order to obtain a first brightness difference therebetween. The calculation module 34 equalizes total brightness value of the central first block 46c and the adjacent first block 46 in case the brightness difference does not exceed a predetermined value so as to obtain a temporary reference brightness value. The comparison module 3404 compares the central first block 46c with respect to the first block 46 succeeding the adjacent first block along the predetermined path P in order to obtain a second brightness difference therebetween. The calculation module 34 equalizes total brightness value of the central first block 46c and succeeding the first block 46 in case the second brightness difference does not exceed the predetermined value so as to obtain a new temporary reference brightness value replacing the temporary reference brightness value. The comparison module 3404 stops the comparison operation once a final brightness difference between the central first block 46c and one of the first block 46 is greater than the predetermined value, thereby obtaining a final temporary reference brightness value. The final temporary reference brightness value defines the reference brightness value.

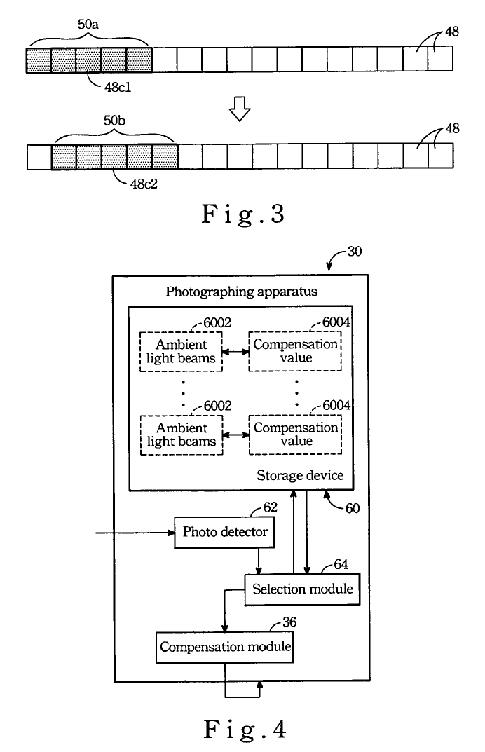

Preferably, the predetermined path P turns in a clockwise direction, as best shown in FIG. 2b. Alternately, the predetermined path P turns in a counter clockwise direction (not shown). FIG. 3 illustrates how the central first block 46c is selected. The predetermined path P is defined by a plurality of the first blocks 48 including middle first block 48c1, and left and right first blocks 50a sandwiching the middle first block. The middle first block 48c1 define the central first block in case the predetermined path is formed by odd number of the first blocks 48. In the same manner, the middle first block defines the central first block 48c2 in case the predetermined path P is formed by even number of the first blocks 48.

The following is an explanation of how the brightness of the second image is compensated. Assuming that the predetermined value is 1.2, the block 46c serving as the central block while the average brightness value is 9. An adjacent block 46 succeeding the central block 46 along the path P is taken for detecting the brightness value. The average brightness value of the adjacent blocks being 9.5 and 10.2, the brightness difference thereof does not exceed the predetermined value 1.2. After equalizing the total brightness, a brightness difference of 9.5 is obtained. Another block 46 is taken for detecting the brightness value with respect to the central block 46c. The average brightness of another block being 10.2 exceeds the predetermined value 1.2 so that a temporary reference brightness of 9.85 is obtained.

Upon reaching the eleventh block 46, the temporary brightness reference 9.7 is obtained. However, the brightness reference between two adjacent blocks 11.2 and 9.7 exceeds the predetermined value 1.2. Under this condition, the eleventh block 46 is taken as the reference image part 42 while the remaining part of the image serves as the non-reference image part 44 of the image. The block in the non-reference image part 44 of the second image is compensated by the second compensation ration. For example, the twelfth block 46 is compensated by a brightness value of 9.7/11.2=0.886.

In addition, the calculation module 34 may include a median filter for eliminating varying brightness difference prior to permit the block calculation module 3402 to calculate average brightness of the respective block according to the pixel value of each of the pixel units 48 of the respective block 46.

Referring again to FIG. 3, the eliminating method includes the steps: (a) fetching the set of the pixel units 48 in odd number, each of the pixel units 48 has a corresponding brightness value; (b) re-arranging the set of the pixel units 48 into a numerical order according to amount of the brightness value, wherein the set of the pixel units 48 includes a middle pixel unit 48c1 with a predetermined brightness value; (c) fetching again the set of the pixel units 48 in odd number according to varying brightness difference value of an adjacent pixel unit in case the set of the pixel units is in odd number; (d) re-arranging the set of pixel units 48 into a numerical order according to the amount of the brightness value in order to obtain the predetermined brightness value of the middle pixel unit; and (e) repeating the steps (c) and (d) again and again in order to eliminate varying brightness value of each pixel unit 48 in the set of the pixel units 48. The varying brightness value is greater than the predetermined brightness value.

Referring to FIG. 4, the photographing apparatus 30 of the present invention further include a storage device 60, a photo detector 62 and a selection module 64. The second compensation ratio preferably includes a plurality of compensation values 6004. The storage device 60 is used for storing different sets of ambient light beams 6002 (light strength) corresponding to the compensation values 6004. The photo detector 62 is used for detecting ambient brightness degree around the photographing apparatus. The selection module 64 selects one set of the ambient light beams 6002 corresponding to a respective one of the compensation values for compensating brightness to the photographing apparatus in operation under the selected set of the ambient light beams 6002.

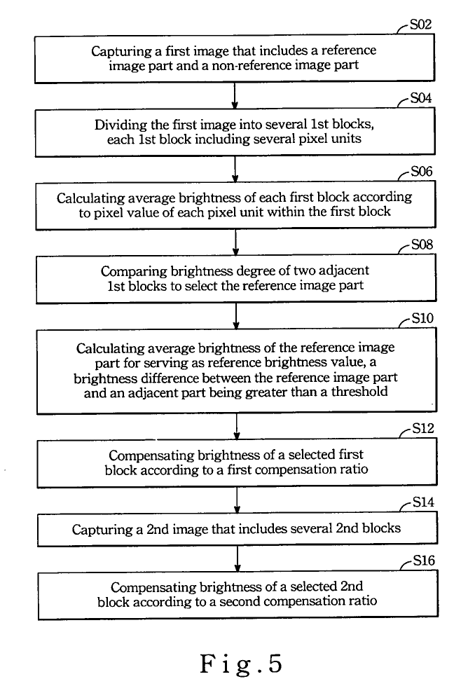

FIG. 5 illustrates the method for compensating brightness to an image within the photographing apparatus 30 of the present invention. The method includes the steps: (S02) capturing a first image, the first image including a reference image part 42 and a non-reference image part 44, wherein the first image can be a white wall; (S04) dividing the white wall into a plurality of first blocks 46, each of the first blocks having a set of pixel units; (S06) calculating average brightness of a respective one of the first blocks 46 according to pixel value of each pixel unit 48 of the respective one of the first blocks 46; (S08) comparing average brightness degree of two adjacent first blocks 46 in order to select the reference image part 42; (S10) calculating average brightness of the reference image part 42 for serving as a reference brightness value, wherein a brightness difference between the reference image part 42 and an adjacent part 44 succeeding the reference image part 42 is greater than a threshold, brightness of the first image and the reference brightness value cooperatively defining a first compensation ratio; (S12) selecting a first block from the non-reference image part in the first image and compensating brightness of the selected first block according to the first compensation ratio; (S14) capturing a second image, the second image including a plurality of second blocks respectively corresponding to the first blocks of the first image in positions, the reference brightness value and brightness value of one of said first blocks cooperatively defining a second compensation ratio; and (S16) selecting one of the second blocks 46 from the non-reference image part 44 of the second image and compensating the selected second block according to the second compensation ratio.

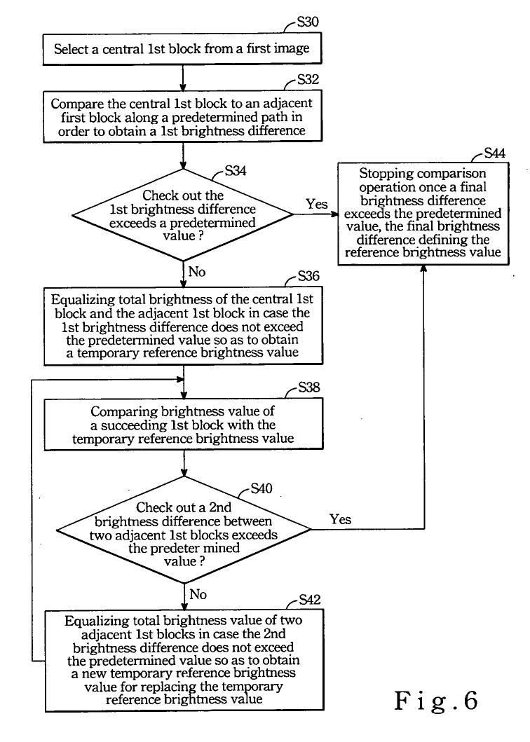

FIG. 6 is a block diagram illustrating how the reference image part 42 is selected. The diagram includes the steps: (S30) selecting a central first block 46c; (S32) comparing the central first block 46c with respect to an adjacent first block along a predetermined path in order to obtain a first brightness difference therebetween; (S34) checking out whether the first brightness difference between the central first block 46c and the adjacent first block exceeds a predetermined value; (S36) equalizing total brightness value of the central first block 46c and the adjacent first block in case the first brightness difference does not exceed the predetermined value so as to obtain a temporary reference brightness value; (S38) comparing the central first block 46c with respect to a first block succeeding the adjacent first block along the predetermined path in order to obtain a second brightness difference therebetween; (S40) checking out whether the second brightness difference exceeds the predetermined value; (S42) equalizing total brightness value of the central first block 46c and succeeding first block in case the second brightness difference does not exceed the predetermined value so as to obtain a new temporary reference brightness value for replacing the temporary reference brightness value; and (S44) stopping comparison operation once a final brightness difference between the central first block and one of the first blocks is greater than the predetermined value, thereby obtaining a final temporary reference brightness value. The final temporary reference brightness value defines the reference brightness value.

In summary, the brightness of the image exhibited within the display panel of the photographing apparatus of the present invention is enhanced (i.e. evenly illuminated) by virtue of the compensation method so that the photo has high quality when it is in the printed format.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A photographing apparatus comprising:
an image sensor for capturing a first image and a second image sequentially, said first image including a reference image part;
a calculation module for calculating average brightness degree of said reference image part as a reference brightness value, wherein a brightness difference between said reference brightness value and average brightness degree of an adjacent part of said first image succeeding said reference image part is greater than a threshold value, brightness of said first image and said reference brightness value cooperatively defining a first compensation ratio; and
a compensation module for compensating brightness of said second image according to said first compensation ratio.

2. The photographing apparatus according to claim 1, wherein said first image includes a background formed by a plurality of first blocks, each of said first blocks having a set of pixel units, said calculation module further including:
a block calculation module for calculating average brightness levels for each of said first blocks according to brightness degree of each of said pixel units within said respective one of said first blocks; and
a comparison module for comparing average brightness degree of two adjacent said first blocks in order to select said reference image part.

3. The photographing apparatus according to claim 2, wherein said background is white.

4. The photographing apparatus according to claim 2, wherein said first image further includes a non-reference image part surrounding said reference image part, said reference brightness value and brightness value of one of said first blocks cooperatively defining a second compensation ratio, said compensation module selecting said one of said first blocks from said non-reference image part and compensating said one of said first blocks according to said second compensation ratio.

5. The photographing apparatus according to claim 4, wherein said second image includes a plurality of second blocks respectively correspond to said first blocks of said first image in positions, said compensation module selecting one of said second blocks from said non-reference image part of said second image and compensating said one of said second blocks the same as said one of said first blocks.

6. The photographing apparatus according to claim 2, wherein said calculation module selects a central first block, comparison module comparing said central first block with respect to an adjacent said first block along a predetermined path in order to obtain a first brightness difference therebetween, said calculation module equalizing total brightness value of said central first block and said adjacent first block in case said brightness difference does not exceed a predetermined value so as to obtain a temporary reference brightness value, said comparison module comparing said central first block with respect to said first block succeeding said adjacent first block along said predetermined path in order to obtain a second brightness difference therebetween, said calculation module equalizing total brightness value of said central first block and succeeding said first block in case said second brightness difference does not exceed said predetermined value so as to obtain a new temporary reference brightness value replacing said temporary reference brightness value, said comparison module stopping comparison operation once a final brightness difference between said central first block and one of said first block is greater than said predetermined value, thereby obtaining a final temporary reference brightness value, said final temporary reference brightness value defining said reference brightness value.

7. The photographing apparatus according to claim 6, wherein said predetermined path turns in a clockwise manner with respect to said central first block.

8. The photographing apparatus according to claim 6, wherein said predetermined path turns in a counter clockwise manner with respect to said central first block.

9. The photographing apparatus according to claim 6, wherein said predetermined path is defined by said first blocks within said reference image part, said reference image part including more than two numbers of said first blocks.

10. The photographing apparatus according to claim 6, wherein said predetermined path is defined by a plurality of said first blocks including a middle first block, and left and right first blocks sandwiching said middle first block, said middle first block defining said central first block in case said predetermined path is formed by odd number of said first blocks, said middle first block defining said central first block in case said predetermined path is formed by even number of said first blocks.

11. The photographing apparatus according to claim 2, wherein said calculation module further includes a median filter for eliminating varying brightness difference prior to permit calculating average brightness of said respective one of said first blocks according to pixel value of each of said pixel units of said respective one of said first blocks by said block calculation module.

12. The photographing apparatus according to claim 11, wherein said varying brightness difference is greater than said predetermined value.

13. The photographing apparatus according to claim 4, wherein under certain ambient light beams, said second compensation ratio being used for compensating said one of said first blocks within said non-reference image part of said first image, said second compensation ratio including a plurality of compensation values, the photographing apparatus further comprising:
a storage device for storing said ambient light beams corresponding to said compensation values;
a photo detector for detecting ambient brightness degree around the photographing apparatus; and
a selection module for selecting one of said ambient light beams corresponding to a respective one of said compensation values for compensating brightness to the photographing apparatus in operation under said one of said ambient light beams.

14. A method for compensating brightness of an image in a photographing apparatus, comprising the steps of:
(1) capturing a first image, said first image including a reference image part;
(2) calculating average brightness degree of said reference image part for serving as a reference brightness value, wherein a brightness difference between said reference image part and an adjacent part succeeding said reference image part is greater than a threshold, brightness of said first image and said reference brightness value cooperatively defining a first compensation ratio;
(3) capturing a second image; and
(4) compensating brightness of said second image according to said first compensation ratio.

15. The compensation method according to claim 14, the compensation method further comprising the steps;
(5) dividing said first image into a plurality of first blocks, each of said first blocks having a set of pixel units;
(6) calculating average brightness of a respective one of said first blocks according to pixel value of each of said pixel units within said respective one of said first blocks;
(7) comparing average brightness degree of two adjacent said first blocks in order to select said reference image part.

16. The compensation method according to claim 15, wherein said first image further includes a non-reference image part surrounding said reference image part, said reference brightness value and brightness value of one of said first blocks cooperatively defining a second compensation ratio, the compensation method further comprising the steps: (8) selecting one of said first blocks from said non-reference image part and compensating said one of said first blocks according to said second compensation ratio.

17. The compensation method according to claim 16, wherein said second image includes a plurality of second blocks respectively correspond to said first blocks of said first image in positions, the compensation method further comprising the step: (9) selecting one of said second blocks from said non-reference image part of said second image and compensating said one of said second blocks the same as said one of said first blocks.

18. The compensation method according to claim 15, further comprising the steps:
selecting a central first block;
comparing said central first blockwith respect to an adjacent said first block along a predetermined path in order to obtain a first brightness difference therebetween;
equalizing total brightness value of said central first block and said adjacent first block in case said brightness difference does not exceed a predetermined value so as to obtain a temporary reference brightness value;
comparing said central first block with respect to said first block succeeding said adjacent first block along said predetermined path in order to obtain a second brightness difference therebetween;
equalizing total brightness value of said central first block and succeeding said first block in case said second brightness difference does not exceed said predetermined value so as to obtain a new temporary reference brightness value for replacing said temporary reference brightness value; and
stopping comparison operation once a final brightness difference between said central first block and one of said first block is greater than said predetermined value, thereby obtaining a final temporary reference brightness value, said final temporary reference brightness value defining said reference brightness value.

19. The compensation method according to claim 18, wherein said predetermined path turns in a clockwise manner with respect to said central first block.

20. The compensation method according to claim 18, wherein said predetermined path turns in turns in a counter clockwise manner with respect to said central first block.
